(19) United States
(12) Patent Application Publication
(10) Pub. No.: US 2010/0046552 A1
(43) Pub. Date: Feb. 25, 2010

(54) TIME-STAMPING APPARATUS AND METHOD FOR RTP PACKETIZATION OF SVC CODED VIDEO, AND RTP PACKETIZATION SYSTEM USING THE SAME

(76) Inventors: Soon-Heung Jung, Daejon (KR); Jae-Gon Kim, Daejon (KR); Jin-Woo Hong, Daejon (KR); Kwang-Deok Seo, Gangwon-do (KR); Chul-Wook Moon, Gangwon-do (KR); Jin-Won Lee, Gangwon-do (KR)

Correspondence Address: LADAS & PARRY LLP, 224 SOUTH MICHIGAN AVENUE, SUITE 1600, CHICAGO, IL, 60604, US

(21) Appl. No.: 12/523,375

(22) PCT Filed: Dec. 18, 2007
(86) PCT No.: PCT/KR07/06636

§ 371 Date: Jul. 16, 2009

(30) Foreign Application Priority Data
Jan. 19, 2007 (KR) 10-2007-0006057
Sep. 21, 2007 (KR) 10-2007-0096872

(51) Int. Cl. H04J 3/24; H04N 11/02

(52) U.S. Cl. 370/474; 375/240.26; 375/E07.026

(57) ABSTRACT

Provided are a<b> </b>time-stamping apparatus and method for RTP packetization of a SVC coded video, and a RTP packetization system using the same. The time stamping apparatus includes: a NAL unit classifier for checking a header of an input NAL unit and classifying the input NAL units based on a picture property; a first timestamp calculator for calculating a RTP timestamp value for a NAL unit classified as a key picture by the NAL unit classifier; a second timestamp calculator for calculating a RTP timestamp value for a NAL unit classified as a non-key picture by the NAL unit classifier; and a controller for setting a RTP timestamp value for an instantaneous decoding refresh (IDR) picture and controlling the first and second timestamp calculators for calculating a RTP timestamp value of a corresponding NAL unit.

### TECHNICAL FIELD

The present invention relates to a time-stamping apparatus and method for real time transport protocol (RTP) packetization of a scalable video coding (SVC) coded video, and a RTP packetization system using the same; and, more particularly, to a time-stamping apparatus and method for the RTP packetization of a SVC coded video, and a RTP packetization system using the same, which set a timestamp value for an instantaneous decoding refresh (IDR) picture that is the first picture of a SVC bit stream and generate a timestamp of a network abstraction layer (NAL) unit using a picture property and a temporal_level (TL) among header information of an inputted NAL unit.

This work was supported by IT R & D program of MIC/IITA [2005-S-103-02, “Development of Ubiquitous Content Access Technology for Convergence of Broadcasting and Communications”].

### BACKGROUND ART

Scalable video coding (SVC) is a H.264 scalable coding technology that was developed to overcome the disadvantages of the scalability of scalable coding in MPEG-2 and MPEG-4, such as a low compression rate, the incapability of supporting integrated scalability, and high embodying complexity.

The SVC encodes a plurality of video layers to one bit sequence. The layers of SVC are constituted of a base layer and scalable layers that can be stacked on the base layer consecutively. Each of the scalable layers can express the maximum bit rate, the maximum frame rate, and a resolution based on the information of lower layers.

Since it is possible to support various bit rates, frame rates, and resolutions in the SVC if a plurality of scalable layers are stacked, the SVC is a coding technology suitable to a multimedia contents service of a universal multimedia access (UMA) that can solve the diversity problems related to bandwidths, the performance of a receiving terminal, resolutions in a heterogeneous network environment.

A SVC coder in a video coding layer (VCL) generates the base layer coding information and the scalable coding information of a scalable layer in a unit of a slice. Each of the generated slices is generated as a network abstraction layer (NAL) unit in a NAL layer again and stored in a SVC bit-stream.

Here, a RTP packetization step is performed to transmit the SVC bit-stream through an Internet protocol (IP) network. In the RTP packetization step, RTP timestamp information must be transmitted to a receiving end by inserting the RTP timestamp information into a RTP header in order to synchronize with different types of media information.

Particularly, it is essential to transmit the RTP timestamp to support lip synchronization between video and audio in a receiving end when a SVC video is serviced with an audio such as AAC.

An international standard for the SVC is not completely prepared, and it is expected to completely prepare the international standard for the SVC by a year of 2007. Therefore, no method for automatically generating a timestamp and recording the timestamp when a SVC bit-stream is loaded in a RTP packet was introduced.

### DISCLOSURE OF INVENTION

### Technical Problem

An embodiment of the present invention is directed to providing a time-stamping apparatus and method for the RTP packetization of a SVC coded video, and a RTP packetization system using the same, which set a timestamp value for an instantaneous decoding refresh (IDR) picture that is the first picture of a SVC bit stream and generate a timestamp of a network abstraction layer (NAL) unit using a picture property and a temporal_level (TL) among header information of an inputted NAL unit.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for generating a timestamp for a real time transport protocol (RTP) packetization of a scalable video coding (SVC) video, including the steps of: a) setting a RTP timestamp value for an instantaneous decoding refresh (IDR) picture; and b) generating a RTP timestamp of a corresponding NAL unit using picture properties and a temporal_level (TL) value among header information of an input network abstraction layer (NAL) unit.

In accordance with an aspect of the present invention, there is provided a time stamping apparatus for a real time transport protocol (RTP) packetization of a scalable video coding (SVC) video, including: a network abstraction layer (NAL) unit classifying unit for checking a header of an input NAL unit and classifying the input NAL units based on a picture property; a first timestamp calculating unit for calculating a RTP timestamp value for a NAL unit classified as a key picture by the NAL unit classifying unit; a second timestamp calculating unit for calculating a RTP timestamp value for a NAL unit classified as a non-key picture by the NAL unit classifying unit; and a controlling unit for setting a RTP timestamp value for an instantaneous decoding refresh (IDR) picture and controlling the first and second timestamp calculating unit for calculating a RTP timestamp value of a corresponding NAL unit.

In accordance with an aspect of the present invention, there is provided a system for real time transport protocol (RTP) packetization of a scalable video coding (SVC) bit-stream, including: a SVC encoding unit for storing coding information, which is generated when an input video sequence is coded based on SVC, in a SVC bit-stream in a form of a network abstraction layer (NAL) unit; a RTP timestamp generating unit for generating a RTP timestamp with reference to a header of a NAL unit generated in the SVC encoding unit; and a RTP packetizer for generating a RTP packet by inserting the generated RTP timestamp in a header of a RTP packet when a RTP packet is generated using the generated NAL unit.

### ADVANTAGEOUS EFFECTS

A time-stamping apparatus and method for the RTP packetization of a SVC coded video, and a RTP packetization system using the same according to the present invention can packetize a SVC video based on a real-time transport protocol (RTP) by setting a timestamp value for an instantaneous decoding refresh (IDR) picture that is the first picture of a SVC bit stream and generating a timestamp of a network abstraction layer (NAL) unit using a picture property and a temporal_level (TL) among header information of an inputted NAL unit although a display order of pictures is different from a coding order of the pictures or a transmit order.

A time-stamping apparatus and method for the RTP packetization of a SVC coded video, and a RTP packetization system using the same according to the present invention can automatically generate a RTP timestamp value that is required for the RTP packetization in order to transmit NAL units having a SVC bit stream through an IP network such as Internet.

### BRIEF DESCRIPTION OF THE DRAWINGS

FIG. 1 is a diagram illustrating a RTP packetization system of a SVC bit-stream in accordance with an embodiment of the present invention.

FIG. 2 is a diagram depicting a time-stamping apparatus for RTP packetization of a SVC video in accordance with an embodiment of the present invention.

FIG. 3 is a diagram showing a RTP packet in accordance with an embodiment of the present invention.

FIG. 4 is a diagram illustrating a header of a NAL unit in accordance with an embodiment of the present invention.

FIG. 5 is a diagram showing a SVC video screen and a hierarchy structure in accordance with an embodiment of the present invention.

FIG. 6 is a flowchart of a method for generating a timestamp for RTP packetization of a SVC video in accordance with an embodiment of the present invention.

FIG. 7 is a diagram for describing a procedure of setting TL_Group and TL_Group_Size in accordance with an embodiment of the present invention.

### MODE FOR THE INVENTION

The advantages, features and aspects of the invention will become apparent from the following description of the embodiments with reference to the accompanying drawings, which is set forth hereinafter.

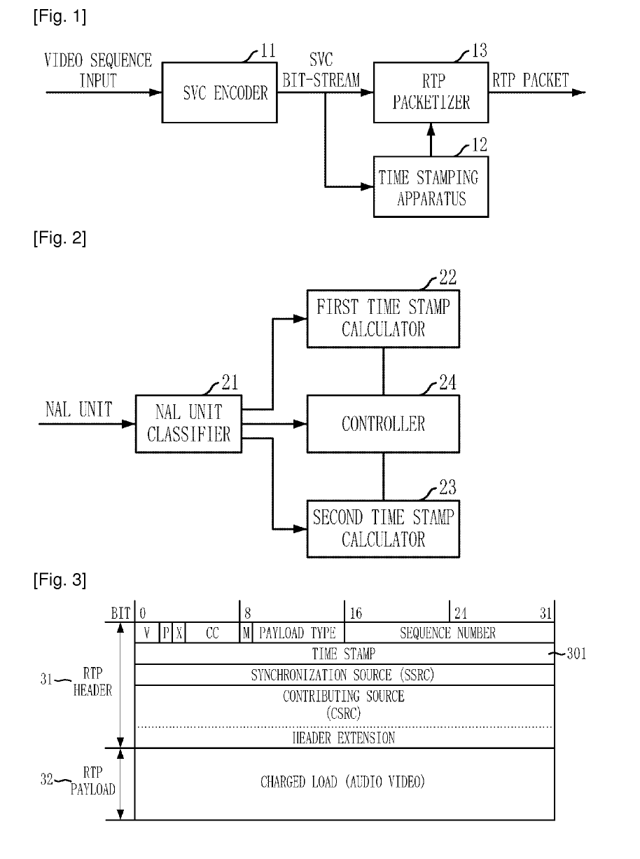

FIG. 1 is a diagram illustrating a RTP packetization system of a SVC bit-stream in accordance with an embodiment of the present invention.

As shown in FIG. 1, a system for packetizing a SVC bit-stream based on a real-time transport protocol (RTP) according to the present embodiment includes a SVC encoder 11, a time-stamping apparatus 12, and a RTP packetizer 13. The SVC encoder 11 stores coding information in a form of a network abstraction layer (NAL) unit, where the coding information is generated when an input video sequence based on scalable video coding (SVC).

The time-stamping apparatus 12 generate a RTP timestamp with reference to a header of a NAL unit generated in the SVC encoder 11. The RTP packetizer 13 generates a RTP packet by inserting a RTP timestamp generated from the time-stamping apparatus 12 in to the header of the RTP packet using the NAL unit generated in the SVC encoder 11.

The SVC bit-stream is constituted of an instantaneous decoding refresh (IDR) picture and at least one of group of pictures (GOP). One GOP includes 16 pictures.

FIG. 2 is a diagram depicting a time-stamping apparatus for RTP packetization of a SVC video in accordance with an embodiment of the present invention. As shown in FIG. 2, the time stamping apparatus for packetizing a SVC video based on a real-time transport protocol (RTP) includes a NAL unit classifier 21, a first time stamp calculator 22, a second time stamp calculator 23, and a controller 24.

The NAL unit classifier 21 classifies NAL units based on the property of a picture by checking the headers of inputted NAL units. The first time stamp calculator 22 using a temporal_level (TL) among header information of NAL units which are classified as a key picture by the NAL unit classifier 21.

The second timestamp calculator 23 calculates a RTP timestamp value with reference to the TL among the header information of NAL units which are classified as non key picture by the NAL unit classifier 21 and an order in a TL group. The controller 24 sets a RTP timestamp value for an instantaneous decoding refresh picture which is the first picture of a SVC bit-stream and controls the first and second timestamp calculators 22 and 23 to calculating a RTP timestamp value of a corresponding NAL unit.

Here, the controller 24 performs another control function for inserting RTP timestamps calculated by the first and second timestamp calculators 22 and 23 to the header of a corresponding RTP packet.

Furthermore, the controller 24 allocates the set RTP timestamp value when a NAL unit corresponding to the IDR picture inputs.

FIG. 3 is a diagram showing a RTP packet in accordance with an embodiment of the present invention. Referring to FIG. 3, the RTP packet according to the present embodiment includes a RTP header 21 and a RTP payload 32.

Here, the RTP header 31 includes a 32-bit timestamp period 301. The timestamp information for a currently transmitted SVC video picture (NAL unit) is recorded in the timestamp period 301.

Here, one SVC video picture includes at least one of NAL units because one SVC video picture is formed by decoding at least one of NAL units.

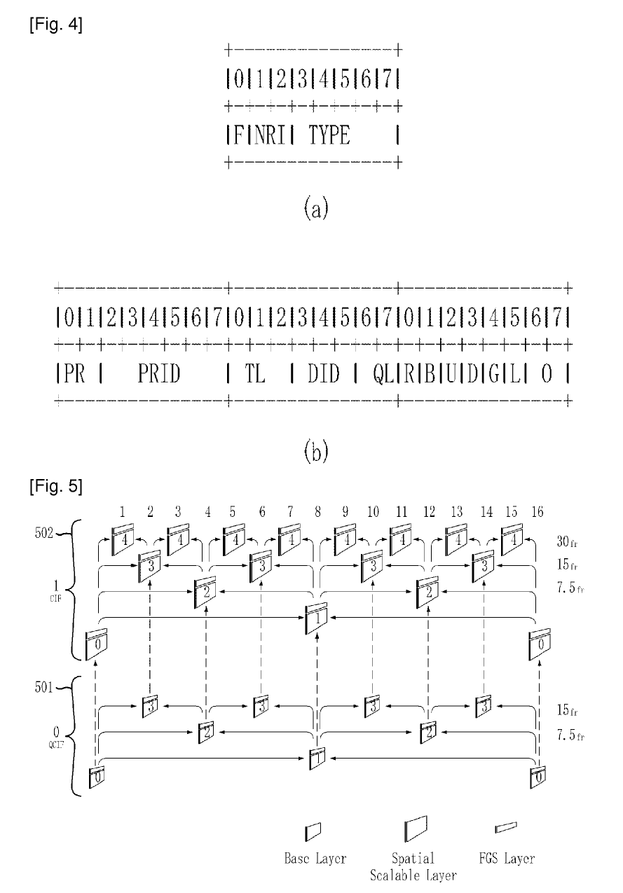

FIG. 4 is a diagram illustrating a header of a NAL unit according to an embodiment of the present invention. The diagram a) shows a header structure of a base layer NAL unit, and the diagram b) shows a header structure of a scalable layer NAL unit.

As shown in FIG. 4, the header structures a) and b) store encoding information generated in SVC. Here, the header structure a) can be compatible with H.264.

Also, a spatio-temporal hierarchy relation for a NAL unit can be derived from a temporal_level (TL), DID, and QL field information of the header structure b).

Information used for generating a timestamp is the TL information representing a hierarchy between temporal layers for temporal scalability.

FIG. 5 is a diagram showing a SVC video picture and a hierarchy structure used in the present invention. As shown in FIG. 5, the SVC video picture and the hierarchy structure denotes an instantaneous decoding refresh (IDR) picture that is a start part of a SVC stream and pictures in the first group among a plurality of GOPs, where the GOP stands for group of picture. One GOP includes total 16 pictures.

Here, the IDR picture is marked with 0, the first B-picture in a GOP is marked with 1, and a key picture the last picture in the GOP is marked with 16. The picture numbers 1 to 16 are matched with an order of displaying the pictures on a monitor.

A supportable picture resolution in the base layer 501 is QCIF, and a supportable picture resolution in the spatial scalable layer 502 is CIF.

A hierarchical B-picture scheme is applied to provide temporal scalability, and a TL value is used for displaying a supportable frame rate among a TL field, a DID field, and a QL filed.

Also, the TL value is displayed at the center of each picture display in a form of rectangle. Here, if only key pictures having TL=0 are transmitted, it is possible to support a frame rate up to 1.875 fps (frame per second). If a B-picture having TL=1 is transmitted with the key pictures, it is possible to support a frame rate up to 3.75 fps.

In addition, in case of transmitting a B-picture having TL=2, it is possible to support a frame rate up to 7.5 fps. In case of transmitting B-pictures having TL=3 and TL=4, it is possible to support a frame rate up to 15 fps and 30 fps.

Since the maximum TL value is 3 in the base layer 501, the frame rate can be supported up to the maximum 15 fps with QCIF. Since the maximum TL value is 4 in the spatial scalable layer 502, the frame rate can be supported up to the maximum 30 fps with CIF.

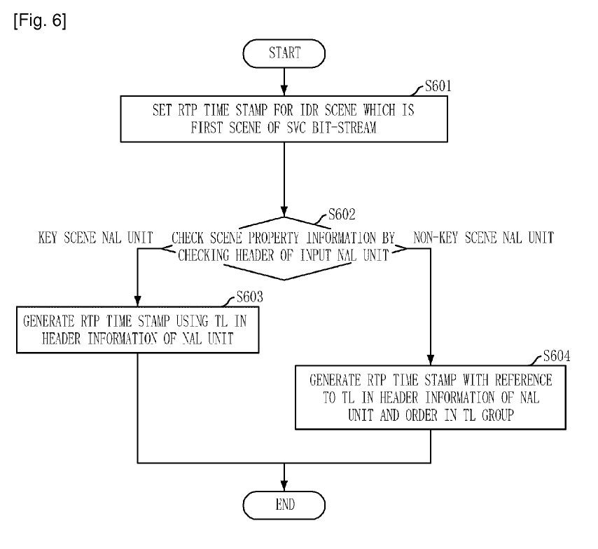

FIG. 6 is a flowchart of a method for generating a timestamp for RTP packetization of a SVC video in accordance with an embodiment of the present invention.

At first, a RTP timestamp value is set for an instantaneous decoding refresh picture that is the first picture of a SVC bit-stream at step S601. The timestamp value of an IDR picture is generally set as 0. However, the timestamp value of the IDR picture may be set as a predetermined number for security purpose. Therefore, if a NAL unit of an IDR picture inputs, the set RTP timestamp value is allocated.

Then, picture property information is confirmed by checking the header of the input NAL unit at step 602.

If the NAL unit is a key picture which is the first picture in a GOP based on the checking result at step S602, a RTP timestamp value is calculated using Eq. 1 at step S603. That is, a RTP timestamp value is calculated using a TL value among the header information of a NAL unit if the input NAL unit is the key picture.

Math Figure 1

TS_{Key}_{_{—}}_{Pic}(T_{MAX})=IDR_TS+Clock_{—}Int×2^{T}^{_{MAX}}×GOP_{—}Num [Math. 1]

In Eq. 1, T_{MAX} denotes the maximum TL value among temporal_level (TL) values of NAL units in a current GOP. A clock interval (Clock_Int) is a time interval of a timestamp value between pictures. IDR_TS denotes a timestamp value for an IDR picture that is the first picture of a SVC stream, and GOP_Num(≧1) denotes an order number of a current GOP among all GOPs in a SVC stream.

Hereinafter, a procedure of calculating a clock interval (Clock_Int) will be described in more detail with reference to FIG. 5.

Since the maximum value of TL is 4, the frame rate can be supportable up to maximum 30 fps in a SVC video picture and a hierarchy structure as shown in FIG. 5. Here, the related standard defines that 90 KHz is used as a sampling clock used for generating a RTP timestamp value for a SVC video picture.

Therefore, the inter-frame clock interval can be calculated through Eq. 2 in case of a video supporting a frame rate up to 30 fps.

$$\begin{matrix}MathFigure 2 & \\ \begin{matrix}Inter \text{-} frame\_Clock \_Interval = \frac{90 \text{,} 000 Hz}{Max\_FR} \\ = \frac{90 \text{,} 000 clock \text{/} s}{30 frame \text{/} s} \\ = 3 \text{,} 000 clock \text{/} frame\end{matrix} & [ Math . 2 ]\end{matrix}$$

According to the confirming result at step S602, if the input NAL unit is not the key picture such as normal picture, a RTP timestamp value is calculated using Eq. 3 at step S604. That is, if the input NAL unit is not a NAL unit of a key picture, a RTP timestamp value is calculated with reference to a TL value or an order in a TL group among the header information of the input NAL unit.

$$\begin{matrix}MathFigure 3 & \\ {TS}_{Pic} ( T , n ) = IDR\_TS + \{ \begin{matrix}Clock\_Int \times {2}^{{T}_{MAX}} \times \\ ( GOP\_Num - 1 )\end{matrix} \} + Clock\_Int \times {2}^{{T}_{MAX} - T} \times ( 2 \times n + 1 ) & [ Math . 3 ]\end{matrix}$$

In Eq. 3,

### T(^{1≦T≦T}^{_{MAX}}⁾

is a TL value in a current picture, n is an order number of a current picture in the same TL_Group, and its range is
0≦n≦TL_Group_Size
.

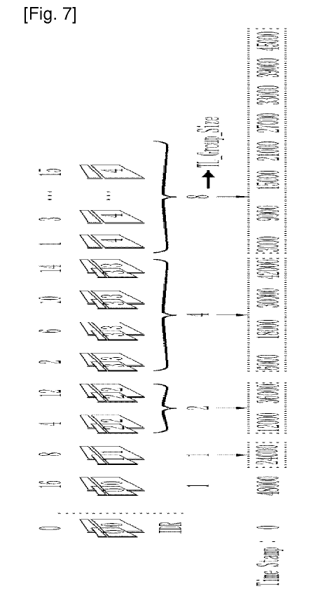

Hereinafter, a procedure of setting TL_Group and TL_Group_Size will be described in more detail with reference to FIG. 7.

FIG. 7 is a diagram for describing a procedure of setting TL_Group and TL_Group_Size in accordance with an embodiment of the present invention. In general, pictures are encoded and transmitted in an order of TL values. That is, the picture having a smaller TL value is encoded and transmitted first.

As shown in FIG. 7, TL_Group denotes a group of pictures (NAL units) having the same TL value in a GOP, and TL_Group_Size denotes the number of pictures in the same TL_Group.

The 16^{th} picture having a TL value of 0 forms an independent TL_Group, and the TL_Group_Size becomes 1.

The 8^{th} picture having a TL value of 1 forms an independent TL_Group, and the TL_Group_Size becomes 1.

The 4^{th} picture and the 12^{th} picture having a TL value of 2 form an independent TL_Group, and the TL_Group_Size becomes 2.

The 2^{nd} picture, 6^{th} picture, 10^{th} picture, and 14^{th} picture, which have a TL value of 3, form an independent TL_Group, and TL_Group_Size becomes 4.

The 1^{st} picture, 3^{rd} picture, 5^{th} picture, 7^{th} picture, 9^{th} picture, 11^{th} picture, 13^{th} picture, and 15^{th} picture, which have a TL value of 4, form an independent TL_Group, and TL_Group_Size becomes 8.

Here, a n value of the first picture in each TL_Groups becomes 0, and a n value of the second picture in each TL_Groups becomes 1. For example, the n value of the second picture in the TL_Group including the 2^{nd} picture, 6^{th} picture, 10^{th} picture and 14^{th} picture becomes 0, and the n value of the 6^{th} picture becomes 1.

In addition, the calculated RTP timestamp may be inserted into a header of a corresponding RTP packet.

As described above, it was described that only one NAL unit exists for one picture. However, a plurality of NAL units may exist for one picture. In addition, if a timestamp value is calculated for the first NAL unit of a picture, it is preferable to use the calculated timestamp value for the other NAL units in the same picture because NAL units in the same picture have the same time information.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application Nos. 2007-0006057 and 2007-0096872, filed in the Korean Intellectual Property Office on Jan. 19, 2007, and Sep. 21, 2007, the entire contents of which is incorporated herein by reference.

While the present invention has been described with respect to certain preferred embodiments, it will be apparent to those skilled in the art that various changes and modifications may be made without departing from the spirits and scope of the invention as defined in the following claims.

### INDUSTRIAL APPLICABILITY

The present invention can be used for RTP packetization of a SVC video.

1. A method for generating a timestamp for a real time transport protocol (RTP) packetization of a scalable video coding (SVC) video, comprising the steps of:
a) setting a RTP timestamp value for an instantaneous decoding refresh (IDR) picture; and
b) generating a RTP timestamp of a corresponding NAL unit using picture properties and a temporal_level (TL) value among header information of an input network abstraction layer (NAL) unit.

2. The method of claim 1, further comprising the step of: c) controlling to insert the generated RTP timestamp into a header of a corresponding RTP packet.

3. The method of claim 1, wherein the step b) includes the steps of:
b-1) confirming a picture property by checking a header of an input NAL unit;
b-2) allocating the set RTP timestamp if the input NAL unit is a NAL unit of an IDR picture;
b-3) generating a RTP timestamp using a TL value if the input NAL unit is a NAL unit of a key picture; and
b-4) generating a RTP timestamp with reference to a TL value and an order in a TL group if the input NAL unit is not a NAL unit of a key picture.

4. The method of claim 3, wherein in the step b-3), a RTP timestamp of a NAL unit is calculated using Equation:
TS_{Key}_{_{—}}_{Pic}(T_{MAX})=IDR_TS+Clock_{—}Int×2^{T}^{_{MAX}}×GOP_{—}Num
, where
T_{MAX}
denotes the maximum TL value among temporal_level (TL) values of NAL units in a current GOP, Clock_Int denotes a time interval of a timestamp value between pictures, IDR_TS denotes a timestamp value for an IDR picture that is the first picture of a SVC stream, and GOP_Num(≧1) denotes an order number of a current GOP among all GOPs in a SVC stream.

5. The method of claim 3, wherein in the step b-4), a RTP timestamp of a NAL unit using Equation:
$${TS}_{Pic} ( T , n ) = IDR\_TS + \{ \begin{matrix}Clock\_Int \times {2}^{{T}_{MAX}} \times \\ ( GOP\_Num - 1 )\end{matrix} \} + Clock\_Int \times {2}^{{T}_{MAX} - T} \times ( 2 \times n + 1 )$$
where
T(^{1≦T≦T}^{_{MAX}}⁾
denotes a TL value in a current picture, n is an order number of a current picture in the same TL_Group, and its range is
0≦n≦TL_Group_Size
.

6. A time stamping apparatus for a real time transport protocol (RTP) packetization of a scalable video coding (SVC) video, comprising:
a network abstraction layer (NAL) unit classifying means for checking a header of an input NAL unit and classifying the input NAL units based on a picture property;
a first timestamp calculating means for calculating a RTP timestamp value for a NAL unit classified as a key picture by the NAL unit classifying means;
a second timestamp calculating means for calculating a RTP timestamp value for a NAL unit classified as a non-key picture by the NAL unit classifying means; and
a controlling means for setting a RTP timestamp value for an instantaneous decoding refresh (IDR) picture and controlling the first and second timestamp calculating means for calculating a RTP timestamp value of a corresponding NAL unit.

7. The time stamping apparatus of claim 6, wherein the first timestamp calculating means calculates a RTP timestamp of a corresponding NAL unit using a temporal_level (TL) value among header information of a NAL unit, and the second time stamp calculating means calculates a RTP timestamp of a corresponding NAL unit with reference to a TL value among header information of a NAL unit and an order in a TL group.

8. The time stamping apparatus of claim 6, wherein the controlling means performs a controlling function of inserting the calculated RTP timestamps from the first and second timestamp calculating means into a header of a corresponding RTP packet.

9. The time stamping apparatus of claim 8, wherein the controlling means allocates the set RTP timestamp value if a NAL unit of an IDR picture inputs.

10. A system for real time transport protocol (RTP) packetization of a scalable video coding (SVC) bit-stream, comprising:
a SVC encoding means for storing coding information, which is generated when an input video sequence is coded based on SVC, in a SVC bit-stream in a form of a network abstraction layer (NAL) unit;
a RTP timestamp generating means for generating a RTP timestamp with reference to a header of a NAL unit generated in the SVC encoding means; and
a RTP packetization means for generating a RTP packet by inserting the generated RTP timestamp in a header of a RTP packet when a RTP packet is generated using the generated NAL unit.

11. The system of claim 10, wherein the RTP timestamp generating means includes:
a NAL unit classifying means for checking a header of an input NAL unit and classifying the input NAL units based on a picture property;
a first timestamp calculating means for calculating a RTP timestamp value for a NAL unit classified as a key picture by the NAL unit classifying means;
a second timestamp calculating means for calculating a RTP timestamp value for a NAL unit classified as a non-key picture by the NAL unit classifying means; and
a controlling means for setting a RTP timestamp value for an instantaneous decoding refresh (IDR) picture and controlling the first and second timestamp calculating means for calculating a RTP timestamp value of a corresponding NAL unit.

12. The system of claim 11, wherein the first timestamp calculating means calculates a RTP timestamp of a corresponding NAL unit using a temporal_level (TL) value among header information of a NAL unit, and the second time stamp calculating means calculates a RTP timestamp of a corresponding NAL unit with reference to a TL value among header information of a NAL unit and an order in a TL group.
